(19) United States
(12) Patent Application Publication
(10) Pub. No.: US 2011/0233490 A1
(43) Pub. Date: Sep. 29, 2011

(54) ULTRAVIOLET AND INFRARED BLOCKING COATING AND METHOD FOR PREPARING THE SAME

(75) Inventors: KUO-LUNG TSAI, TAINAN COUNTY (TW); CHANG-NENG HSIAO, TAOYUAN COUNTY (TW); MING-SHENG WANG, TAINAN COUNTY (TW)

(73) Assignee: UNIVACCO TECHNOLOGY INC., TAINAN HSIEN (TW)

(21) Appl. No.: 12/732,606

(22) Filed: Mar. 26, 2010

(51) Int. Cl. F21V 9/04; F21V 9/06

(52) U.S. Cl. 252/587; 977/773

(57) ABSTRACT

An ultraviolet (UV) and infrared (IR) blocking coating and a method for preparing the same are revealed. The coating provides functions of UV blocking and IR blocking by addition of nanoparticles that blocks UV rays and IR rays, or by other additives with the same functions such as organic/inorganic compounds or dyes.

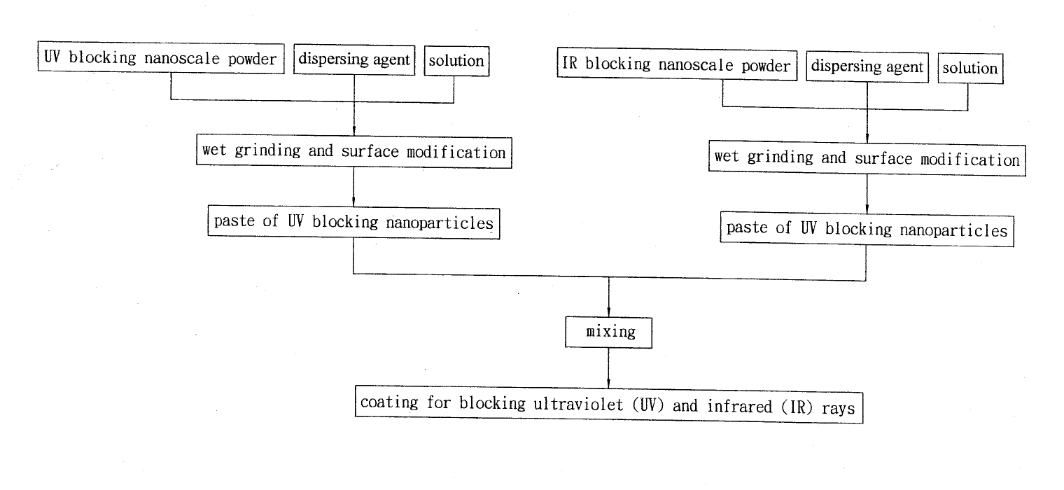

### BACKGROUND OF THE INVENTION

1. Fields of the Invention

The present invention relates to an ultraviolet (UV) and infrared (IR) blocking coating and a method for preparing the same, especially to a coating applied to thermal insulation films.

2. Descriptions of Related Art

Manufacturing ways of heat insulation films include sputtering, sol-gel coating, coating of nanoscale thermal insulation coatings, etc. The coating of nanoscale thermal insulation coatings has several advantages such as that the coatings are resistant to oxidation and no interference with wireless communication. Compared with coating of nanoscale thermal insulation coatings, sol-gel has a shortcoming of fading while disadvantages of the sputtering are oxidation of metal coatings and interference with radio waves.

Generally, nanopartilces applied to thermal insulation coatings come from antimony doped tin oxide (ATO) powder, indium tin oxide (ITO) powder, Lanthanum hexaboride (LaB₆) powder, etc. After nano processing, these powders have excellent visible light transmission and infrared (IR) rejection. Once these nanoparticles are added in a certain ratio to coatings, energy saving coatings with excellent properties are obtained.

Although above nanoparticles provide excellent infrared reflective properties, they have no Ultraviolet (UV) resistance. UV provides only 5% of the solar energy and having a wavelength shorter than 380 nm. UV light can cause color fading on irradiated objects and damages to humans such as skin cancer, cataracts, etc. Thus besides thermal insulation and IR blocking, heat insulation films still require the function of UV blocking. In common heat insulation films, UV-absorbers are added into pressure sensitive adhesives (PSA) so as to block UV light. The UV-absorbers are organic compounds with aging problems. Thus a better way is to apply inorganic additives with UV resistance such as nanoscale zinc oxide (ZnO) to heat insulation coatings.

The UV resistance not only protects humans but also shields thermal insulation materials. The nanoparticles with thermal insulation properties have no UV blocking function. Thus after exposure to UV light, the nanoparticles fade, weaken, and finally lose their functions.

In order to overcome this shortcoming of nanoparticles with thermal insulation properties, a UV and IR blocking coating of the present invention is developed so as to protect both human bodies and nanoparticles with thermal insulation.

### SUMMARY OF THE INVENTION

Therefore it is a primary object of the present invention to provide a functional coating blocking UV and IR rays and formed by addition of both UV blocking nanopartilces and IR blocking particles, or organic/inorganic compounds with the same properties.

In order to achieve the above object, firstly prepare a paste containing UV blocking nanoparticles and a paste containing IR blocking nanoparticles respectively. While preparing, UV blocking powder and IR blocking powder respectively are added with a dispersing agent and methyl ethyl ketone. Then the mixtures are respectively set into a ball milling machine for wet grinding, and surface modification. After preparation of the paste containing UV blocking nanoparticles and the paste containing IR blocking nanoparticles, resin is added into mixture of the pastes to form the coating.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

The FIGURE is a flowchart of the present invention.

### DETAILED DESCRIPTION OF THE PREFERRED EMBODIMENT

A UV and IR blocking coating according to the present invention include nanoparticles with UV and IR blocking properties or organic/inorganic compounds with the same properties, at least one dispersing agent, methyl ethyl ketone (MEK), and resin, wherein the MEK is used first to prepare pastes separately containing UV and IR blocking nanoparticles and then both mixed with resin to become a functional coating. The functional coating with UV resistance and IR blocking is obtained by mixing of all components. The nanoparticles with UV resistance are made of ZnO powder and a dispersing agent used in producing nanoparticles with UV resistance has a hydroxyl value of 20-30 mgKOH/g while the optimal amount of the UV blocking naneparticles is 5-15 wt % (weight percentage). The nanoparticles with IR blocking are made of one or more powders of the following group: ATO, ITO and LaB₆. A dispersant used in producing the nanoparticles with IR blocking has an acid value of 10-30 mgKOH/g.

As the IR blocking particle used in the paste containing IR blocking nanoparticles is the ATO powder, a dispersant on dispersion of ATO powder has an acid value of 20-30 mgKOH/g and the optimal amount of the paste containing IR blocking nanoparticles ranges from 10 wt % to 20 wt %. A dispersant on dispersion of ITO powder has an acid value of 10-20 mgKOH/g as the IR blocking particle used in the paste containing IR blocking nanoparticles is the ITO powder and the optimal amount the paste containing IR blocking nanoparticles ranges from 10 wt % to 15 wt %. As the IR blocking particle used in the paste containing IR blocking nanoparticles is the LaB₆ powder, a dispersant on dispersion of the LaB₆ has an acid value of 15-20 mgKOH/g, and the optimal amount of the paste containing IR blocking nanoparticles is 5-8 wt %. When the paste containing IR blocking nanoparticles is formed by a mixture of pastes respectively containing ATO, ITO and LaB₆ naneparticles, the preferred ratio is as following: a paste containing ATO nanoparticle: 20-30 wt %, a paste containing ITO nanoparticle: 0-10 wt %, a paste containing LaB₆ nanoparticle: 0.5-2 wt %. At this time the amount of the UV blocking paste containing ZnO naneparticles, mixed with the paste containing IR blocking nanoparticle, ranges from 0.5 wt % to 5 wt %.

Moreover, a method for preparing UV/IR blocking coatings includes at least following three steps:

(a) processing IR blocking nanoscale powder by wet grinding and surface modification: setting IR blocking powder, at least one dispersing agent and MEK into a ball milling machine for ball milling dispersion and surface modification so as to form a paste containing IR blocking nanoparticles.
(b) processing UV blocking nanoscale powder by wet grinding and surface modification: setting UV blocking powder, at least one dispersing agent and MEK into a ball milling machine for ball milling dispersion and surface modification so as to form a paste containing UV blocking nanoparticles.
(c) mixing and blending components to form coatings: after milling dispersion and surface modification, the paste containing IR blocking nanoparticles, the paste containing UV nanoparticles and resin are mixed well in a certain ratio so as to get a UV and IR blocking coating.

The preferred UV blocking nanoparticles are made of ZnO powder while the IR blocking nanoparticles are made from ATO powder, ITO powder, and LaB₆ powder. How the paste containing IR blocking nanoparticles and the paste containing UV nanoparticles are prepared is described in details in the following.

### (A) Paste Containing UV Blocking Nanoparticles

Take 100 g ZnO powder (primary particle size is 20-30 nm), 10 g dispersing agent with a hydroxyl value of 20-30 mgKOH/g, and 90 g MEK into a ball milling machine for ball milling dispersion. In the ball milling machine, milling balls are zirconium oxide beads whose diameter range from 0.2 mm to 0.3 mm with a rotation speed of 2830 rpm. The milling ball to powder ratio is 70% and the milling time is 1 hour. After dispersion, solid content of the paste is 50%. Use a particle size distribution analyzer to characterize particle size distribution and the particle size distribution is given by D(90)=20 nm.

### (B) Paste Containing IR Blocking Nanoparticles

(1) Take 100 g ATO powder (primary particle size is 20-40 nm), 10 g dispersing agent with a hydroxyl value of 20-30 mgKOH/g, and 90 g MEK into a ball milling machine for ball milling dispersion. In the ball milling machine, milling balls are zirconium oxide beads whose diameter range from 0.2 mm to 0.3 mm with a rotation speed of 2830 rpm. The milling ball to powder ratio is 70% and the milling time is 1 hour. After dispersion, solid content of the paste is 50%. Use a particle size distribution analyzer to characterize particle size distribution and the particle size distribution is given by D(90)=40 nm.
(2) Take 100 g ATO powder (primary particle size is 20-30 nm), 10 g dispersing agent with a hydroxyl value of 10-20 mgKOH/g, and 90 g MEK into a ball milling machine for ball milling dispersion. In the ball milling machine, milling balls are zirconium oxide beads whose diameter range from 0.2 mm to 0.3 mm with a rotation speed of 2830 rpm. The milling ball to powder ratio is 70% and the milling time is 1 hour. After dispersion, solid content of the paste is 50%. Use a particle size distribution analyzer to characterize particle size distribution and the particle size distribution is given by D(90)=30 nm.
(3) Take 20 g LaB₆ powder (primary particle size is 2 micro meter (μm)), 10 g dispersing agent with a hydroxyl value of 15-20 mgKOH/g, and 170 g MEK into a ball milling machine for ball milling dispersion. In the ball milling machine, milling balls are zirconium oxide beads whose diameter range from 0.2 mm to 0.3 mm with a rotation speed of 2830 rpm. The milling ball to powder ratio is 70% and the milling time is 1 hour. After dispersion, solid content of the paste is 20%. Use a particle size distribution analyzer to characterize particle size distribution and the particle size distribution is given by D(90)=60 nm.

The paste containing UV blocking nanoparticles and the paste containing IR blocking nanoparticles are mixed with resin to form UV and IR blocking coatings. The coatings are divided into two groups-group A and group B. The group A includes the paste containing IR blocking nanoparticles but without addition of the paste containing UV blocking nanoparticles while the group B includes both the paste containing IR blocking nanoparticles added with the paste containing UV blocking nanoparticles. After preparation, the coatings are coated over PET membrane by a wire rod (number 8). The size of the PET membrane is 20×30 cm and the thickness thereof is 38 p.m. Then the PET membrane with coating is set into an oven, heated at 90° C. for 1 minute and irradiated by UV light so as to cure the resin. The product of the PET membrane with the coating is tested by an ultraviolet spectrometer (190-2200 nm) and a QUV accelerated weathering tester. In the QUV test, the temperature is set at 60 degrees Celsius (° C.), at a relative humidity of 60%, under UV radiation (340 nm) for 8 hours. Then the temperature is reduced to 50° C. and is irradiated for 4 hours. A cycle is 12 hours. The duration of the QUV test is 500 hours.

The following list shows test results of samples in the group A and the group B

| Sample Group | A | B |
|---|---|---|
| components | ATO: 30% | ATO: 30% |
| | ITO: 10% | ITO: 10% |
| | LaB₆: 2% | LaB₆: 2% |
| | ZnO: 0% | ZnO: 1% |
| | Solvent/ | Solvent/ |
| | resin: balance | resin: balance |
| UV light transmission | 16% | 3% |
| (190-400 nm) | | |
| visible light transmission | 65% | 63% |
| (400-760 nm) | | |
| infrared ray transmission | 20% | 21% |
| (760-2220 nm) | | |
| QUV test | ΔE = 3.0 | ΔE = 0.9 |

According to the above list, the UV light transmission of the sample B reduces from 16% to 3% due to 1% of ZnO it contains. As to the visible light transmission and the infrared ray transmission, the two groups have no significant difference. That means after addition of ZnO powder, the coating also provides UV resistance besides IR blocking (thermal insulation).

Moreover, in the QUV test, the coating added with nanoscale ZnO has ΔE=0.9. This means the color change is unable to be observed by naked eyes.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A method for preparing a coating that blocks ultraviolet (UV) and infrared (IR) rays comprising the steps of
processing UV blocking powder as well as IR blocking powder by wet grinding and surface modification, adding with at least one dispersing agent and at least one solvent so as to form a paste containing UV blocking nanoparticles and a paste containing IR blocking nanoparticles respectively;
mixing the paste containing UV blocking nanoparticles, the paste containing IR blocking nanoparticles, with resin well so as to get a functional coating for blocking of UV and IR rays.

2. The method as claimed in claim 1, wherein the wet grinding and surface modification are performed by ball milling in which the UV blocking powder and the IR blocking powder are respectively set into a ball milling machine with milling balls for ball milling dispersion and surface modification so as to form the paste containing UV blocking nanoparticles and the paste containing IR blocking nanoparticles.

3. A coating that blocks ultraviolet (UV) and infrared (IR) rays comprising: resin, a paste containing one component of UV and IR blocking nanoparticles, organic or inorganic additives having UV and IR blocking properties, mixed well with one another.

4. The coating as claimed in claim 3, wherein the paste containing UV blocking nanoparticles includes UV blocking powder, at least one dispersing agent and methyl ethyl ketone.

5. The coating as claimed in claim 4, wherein the UV blocking powder is zinc oxide (ZnO) powder.

6. The coating as claimed in claim 5, wherein a dispersing agent for the ZnO powder has a hydroxyl value of 20-30 mgKOH/g, and an optimal amount of the paste containing UV blocking naneparticles of ZnO powder ranges from 5 wt % to 15 wt %.

7. The coating as claimed in claim 3, wherein the paste containing IR blocking nanoparticles includes IR blocking powder, at least one dispersing agent and methyl ethyl ketone.

8. The coating as claimed in claim 7, wherein the IR blocking powder is chosen from one or more of antimony doped tin oxide (ATO) powder, indium tin oxide (ITO) powder, Lanthanum hexaboride (LaB₆) powder.

9. The coating as claimed in claim 8, wherein a dispersing agent for the ATO powder has an acid value of 20-30 mgKOH/g, and the amount of the paste containing IR blocking naneparticles of ATO powder ranges from 10 wt % to 20 wt %.

10. The coating as claimed in claim 8, wherein a dispersing agent for the ITO powder has an acid value of 10-20 mgKOH/g, and the amount of the paste containing IR blocking naneparticles of ITO powder ranges from 10 wt % to 15 wt %.

11. The coating as claimed in claim 8, wherein a dispersing agent for the LaB₆ powder has an acid value of 15-20 mgKOH/g, and the amount of the paste containing IR blocking naneparticles of LaB₆ powder ranges from 5 wt % to 8 wt %.

12. The coating as claimed in claim 3, wherein the paste containing UV blocking nanoparticles includes UV blocking ZnO powder, at least one dispersing agent and methyl ethyl ketone; the paste containing IR blocking nanoparticles includes IR blocking powder being composed of ATO powder, ITO powder, and LaB₆ powder, at least one dispersing agent and methyl ethyl ketone; each of the ATO powder, ITO powder, and LaB₆ powder is mixed with a dispersing agent and methyl ethyl ketone and milled as three kinds of pastes containing ATO, ITO and LaB₆ naneparticle, respectively; the three kinds of pastes are then mixed with the paste containing UV blocking nanoparticles to obtain a functional coating; the amount of each kind of pastes used in the coating is as following: the paste containing ATO nanoparticle: 20-30 wt %, the paste containing ITO nanoparticle: 0-10 wt %, the paste containing LaB₆ nanoparticle: 0.5-2 wt % and the paste containing UV blocking naneparticles of ZnO powder: 0.5-5 wt %.
